(19) United States
(12) Patent Application Publication
(10) Pub. No.: US 2005/0252385 A1
(43) Pub. Date: Nov. 17, 2005

(54) Soup supplying apparatus

(75) Inventors: Tadashi Nagasaki, Chiyoda-ku (JP); Masahiro Kato, Chiyoda-ku (JP)

Correspondence Address: PEARNE & GORDON LLP, 1801 EAST 9TH STREET, SUITE 1200, CLEVELAND, OH, 44114-3108, US

(73) Assignee: Fuji Electric Retail Systems Co., Ltd., Tokyo (JP)

(21) Appl. No.: 10/992,899

(22) Filed: Nov. 19, 2004

(30) Foreign Application Priority Data
May 12, 2004 (JP) P2004-141881

(51) Int. Cl. A23L 1/00

(52) U.S. Cl. 99/348

(57) ABSTRACT

A soup supplying apparatus includes a vessel 5 with an opening, for accommodating a soup, a ladling member 11 with a ladling mouth 11a on the front for ladling the soup within the vessel 5, a mechanism 8 provided with the ladling member 11 at its one end which rotatively moves in the vessel 5, a driving device 26 for rotatively moving the mechanism, and a separating member 38, arranged to partition the interior 11b into a ladling mouth 11a side and a inner side at a position at a predetermined distance from the lading mouth 11a of the ladling member 11, for passing the soup without passing the substances mixed in the soup. The ladling member 11 has a through-hole 20a formed on the upper portion and leading to the interior 11b.

### BACKGROUND OF THE INVENTION

1. Field of the Invention

The present invention relates to a soup supplying apparatus for supplying customers with a prescribed sub-divided quantity of soup such as stew, soup, curry and miso soup accommodated in a vessel.

2. Description of the Related Art

Such a previously known soup supplying apparatus is described in Japanese Patent No. 3449554. This soup supplying apparatus is one in which sub-divided predetermined quantities of soup containing substances accommodated in the vessel are distributed to a plateware. The soup supplying apparatus includes a vessel having an opening, for accommodating a soup; a axis which is rotated by a prescribed driving force; a linkage mechanism attached to the axis which rotates in the vessel; a ladle attached to the tip of the linkage mechanism and having a ladling mouth oriented toward the opening the vessel; and a ladle leaning means for leaning the ladle when the ladle reaches the opening of the vessel in synchronization with the rotation of the rotary shaft. In this apparatus, when the ladle arranged in the vessel containing the soup rotates toward the opening in synchronization with the rotary shaft, the soup is accommodated into the ladle. When the ladle reaches the opening of the vessel, the ladle accommodating the soup is leaned by the ladle leaning means so that the soup within the ladle is sub-divided into the plateware. In this way, subdivided quantities of soup are given to customers.

Further, this soup supplying apparatus is designed in such a manner that where the soup accommodated in the vessel is kept warm, the linkage mechanism swings in the vessel to rotatively move the ladle provided at its tip within the vessel so that the soup within the vessel is stirred.

Further, the ladle incorporates a separating member (partitioning plate) for separating substances and soup liquid from each other when accommodating the soup from the ladling mouth, thereby permitting the substances and soup liquid accommodated at a prescribed ratio to be sub-divided into the plateware.

### SUMMARY OF THE INVENTION

Meanwhile, the ladle in the above conventional soup supplying apparatus incorporates a partitioning plate for accommodating substances and soup liquid separated from each other when the soup is internally accommodated from the ladling mouth. As regards the partitioning plate, according to the kind or status of the soup, the ingredient may be deposited on the front surface of the partitioning plate. In this case, the soup liquid is difficult to proceed into the back of the ladle where the soup is accommodated. This presents a problem that where the soup ladled by the ladle is sub-divided into the plateware, a prescribed quantity of the soup liquid cannot be ladled up. In order to obviate such an inconvenience, the deposits must be removed by diligently cleaning the partitioning plate, for example. This presents a problem that handling the apparatus becomes troublesome.

Further, where the soup within the vessel is ladled up by the ladle, it is desirable that the substances and the soup liquid are ladled up at a prescribed ratio in such a manner that the soup liquid is accommodated in the ladle on the inner side with respect to the partitioning plate whereas the substances are accommodated in the ladle on the ladling mouth side before the portioning net. However, actually, on the ladling mouth side before the portioning net, the soup liquid and substances are accommodated in their mixed state. In this case, the ratio between the soup liquid and substances accommodated in the ladling mouth side is affected by the ratio in the soup so that if the quantity of the substances in the soup accommodated in the vessel becomes little, the quantity of the substances accommodated in the ladling mouth side also becomes little. As a result, the soup cannot be ladled up at a prescribed ratio between the substances and the soup liquid.

In order to solve the above problems, the present invention intends to provide a soup supplying apparatus which even where a soup liquid is difficult to be accommodated in the inner or back side of a ladle owing to deposition of substances on the separating member such as a partitioning plate, can accommodate the soup liquid in the inner side of the ladle, and even where the percentage of the substances in the soup accommodated within the vessel is decreased, can always ladled up the substances and soup liquid at a prescribed ratio therebetween when the soup within the vessel is ladled up by the ladle and sub-divide them to an plateware in such a manner that the quantity of the substances accommodated in the ladling mouth side of the ladle before the separating member does not little.

According to one aspect of the invention, there is provided a soup supplying apparatus including: a vessel having an opening and accommodates a soup therein; a ladling member having a ladling mouth and ladles up the soup accommodated in the vessel; a linkage mechanism provided with the ladling member at one end thereof; a driving device that rotatively moves the linkage mechanism for ladling up the soup within the vessel and supplying the sub-divided soup into a plateware through the opening; and a separating member arranged at a position where is backed off from the ladling mouth with a predetermined distance to partition an interior portion of the ladling member into a ladling mouth section and a soup accommodating section, and passes a soup without passing substances mixed in the soup therethrough, wherein the ladling member has a through-hole formed thereon at a upper part thereof and leading to the soup accommodating section.

### BRIEF DESCRIPTION OF THE DRAWINGS

The above and other objects and advantages of the present invention will become more fully apparent from the following detailed description taken with the accompanying drawings, in which:

FIG. 1 is an appearance perspective view showing a soup supplying apparatus according to an embodiment of the present invention;

FIG. 2 is a front sectional view showing the internal structure of the soup supplying apparatus according to the embodiment;

FIG. 3 is a front sectional view showing the internal structure of the soup supplying apparatus according to the embodiment;

FIG. 4 is a perspective view of the a soup supplying apparatus according to an embodiment of this invention when the upper cover covering the opening of the upper portion of an apparatus body has been rotated upward to open;

FIG. 5 is a perspective view of the configuration of the linkage mechanism and vessel in the soup supplying apparatus according to the embodiment;

FIG. 6 is a front view of the ladle used in the soup supplying apparatus according to the embodiment;

FIG. 7 is a front view of the ladle used in the soup supplying apparatus according to the embodiment;

FIG. 8 is a plan view of the ladle used in the soup supplying apparatus according to the embodiment;

FIG. 9A shows the state when the linkage mechanism in the vessel has rotatively moved from a stand-by state to a predetermined position in the opening (ladling mouth) direction of the ladle;

FIG. 9B shows the state where the linkage mechanism in the vessel has rotatively moved to a predetermined position in the direction opposite to the opening of the ladle;

FIG. 9(c) shows the state when the linkage mechanism further rotatively moves again in the opening direction of the ladle so that the ladle has been inserted into the wide mouth of the hopper; and

FIG. 9(d) shows the state when the ladle inserted in the hopper rotatively moves over the opening of the vessel to the outside thereof so that the soup in the ladle is poured into an plateware from a cylindrical mouth of the hopper.

### DETAILED DESCRIPTION OF THE PREFERRED EMBODIMENTS

Referring now to the accompanying drawings, a description will be given in detail of a preferred embodiment of the invention.

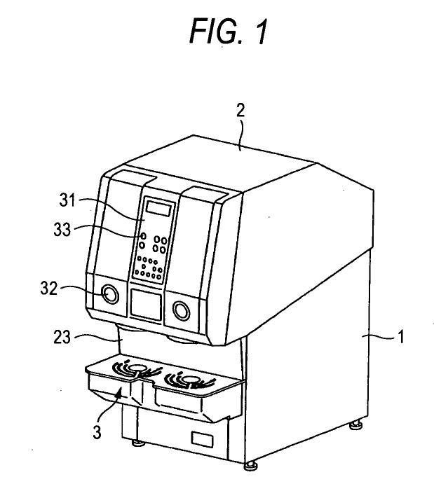

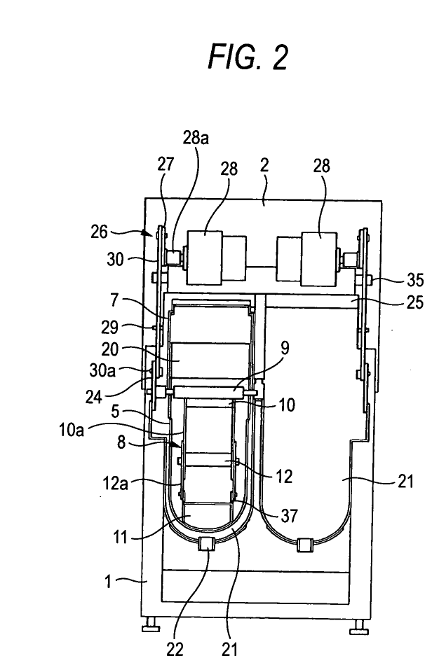

As can be seen from FIGS. 1-5, the soup supplying apparatus includes an apparatus body 1 for holding a vessel 5 accommodating a soup, an upper cap 2 openably covering the upper part of the body 1 and plateware placing portions 3 each located in front of the body 1 where a plateware 16 into which the soup is sub-divided is placed.

The apparatus body 1 includes two vessel holding portions 21 each for holding a vessel 5 accommodating the soup. The vessel holding portion 5 is, on its bottom, provided with a heating device 22 for heating and keeping warm the soup accommodated in the vessel 5. The vessel holding portions 21 each is provided, on the front thereof, is provided with a recess 21a where the vessel is attached or detached. The apparatus body 1 is provided with a detachable front cover 23 covering the recesses 21a.

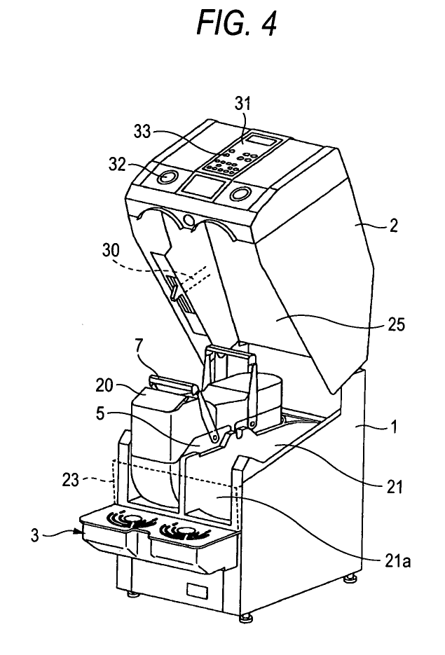

The upper cap 2 includes a cover 25 for covering the upper portion of the vessel 5 held in the vessel holding portion 21; a driving device (driving unit) 26 arranged on the cover 25, which includes a driving motor 28 for driving a ladle 11 for ladling the soup in the vessel 5; and a control panel 31 arranged to orient forward in front of the driving device 26 and provided with sub-division switches 32 each for starting the sub-division operation of the soup and setting buttons 33 for setting a soup warm-keeping temperature and others. The upper cap 2 is rotatably vertically linked with the apparatus body 1 by a supporting shaft 35 located at the rear. By rotating upward the upper cap 2 to open the upper part of the apparatus body 1 and detaching the front cover 23 (see FIG. 4), the vessel 5 accommodating the soup can be easily attached to or detached from the vessel holding portion 21 from the front of the apparatus body 1.

The plateware placing portion 3 has a placing stand 17 on which the plateware 16 is placed, and a soup recovering bucket 18 which serves to recover and accumulate the soup spilled when the soup is sub-divided into the plateware 16. The plateware 3 is detachably locked to the front of the apparatus body 1 by a hook 19.

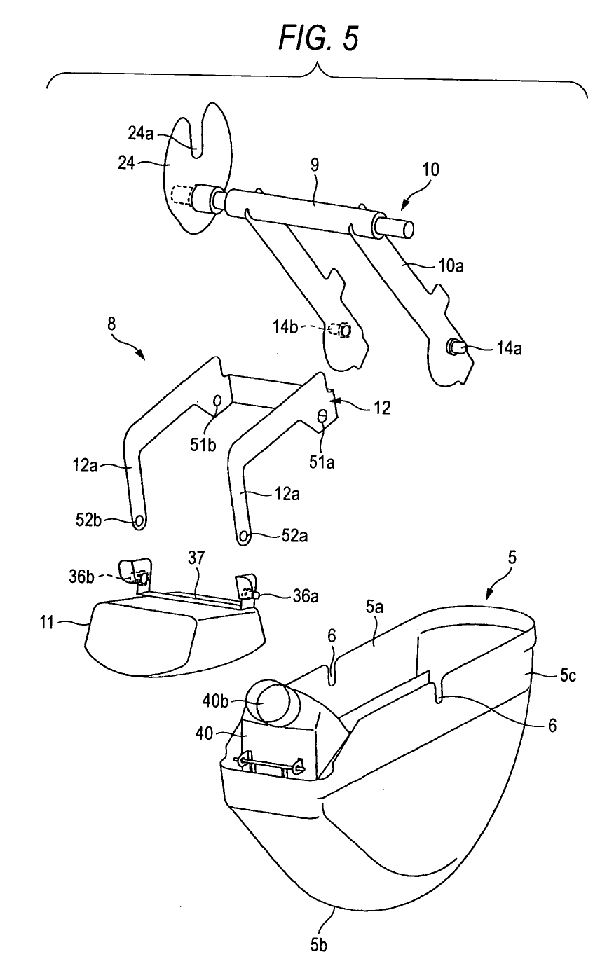

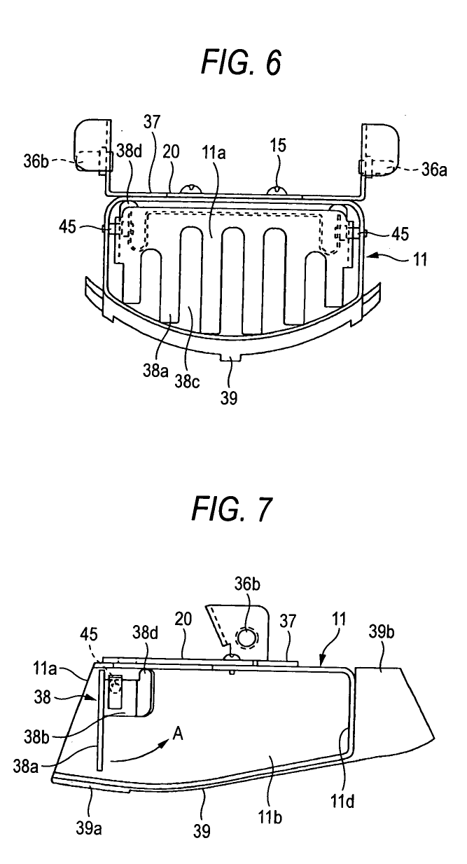

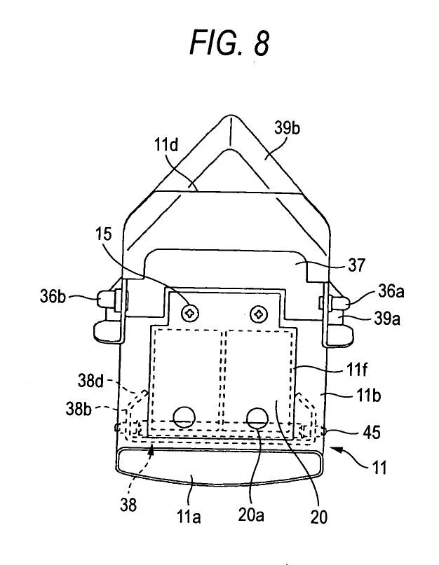

The vessel 5 accommodating the soup 5 is formed in a semi-circular shape when viewed from the side. A bottom 5b is formed along the arc portion and an opening 5a is formed at the chord (see FIG. 5). A hopper 40 that rotatively moves outwardly through the opening 5a is journaled on the inside of the upper end of the bottom 5b. The bottom 5b is formed as a semi-circular curve with side portions 5c formed on both left and right sides thereof.

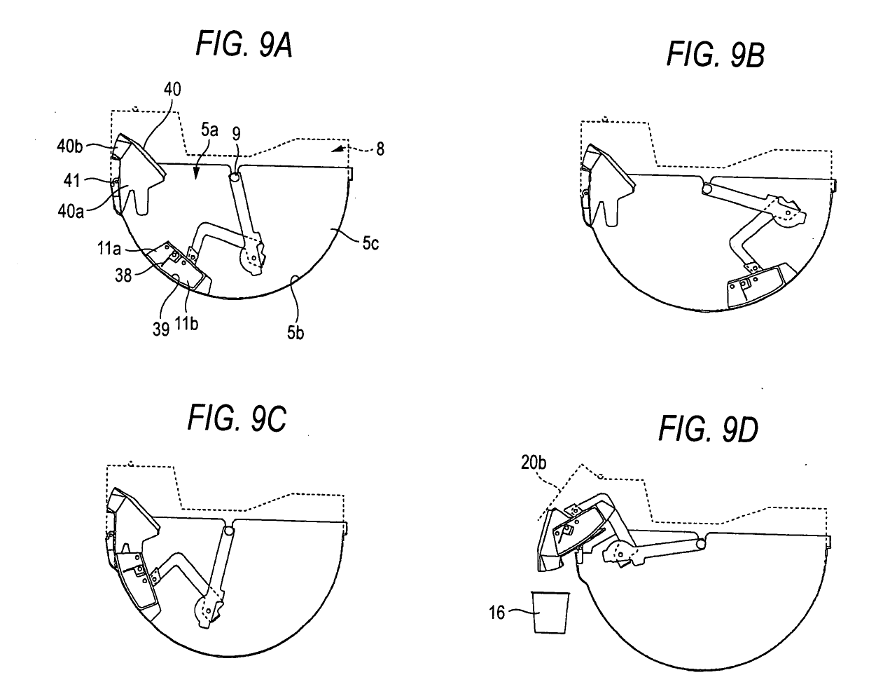

A hopper 40 is rotatably supported or journaled on the vessel 5 by a supporting shaft 41. The hopper 40 includes a wide mouth 40a (described later) into which the ladle 11 is inserted and a cylindrical mouth 40b from which the soup ladled by the ladle 11 is poured into the plateware 16 (FIG. 9).

The linkage mechanism 8 arranged in the vessel 5 includes a rotary shaft 9, a rotary arm member 10 composed of a pair of square pieces 10a provided perpendicular to the rotary shaft 9 and a [symbol] -shape swing arm member 12 which is journaled to the tip of the rotary arm member 10 and a ladle 11 which is rotatably supported or journaled to the open end of the swing arm member 12.

At the tip of the pair of square pieces 10a which are provided on the rotary shaft 9 to constitute a rotary arm member 10, locking pins 14a, 14b are protruded outwardly for journaling the swing arm member 12. The swing arm member 12, in the vicinity of the base of a pair of tongue pieces 12 bent in parallel, is provided with opposite pin holes 51a, 51b in which the locking pins 14a, 14b are to be fit, respectively. At the tip of the swing arm member 12, coupling holes 52a, 52b are formed for coupling the ladle 11 with the swing arm member 12. On the ladle 11, a coupling plate 37 is placed which is provided with protrusive coupling pins 36a, 36b which are be fit in the coupling holes 52a, 52b of the swing arm member 12.

The linkage mechanism 8 is journaled, in its both ends of the rotary shaft 9, by the U-shaped grooves 6 formed on both sides 5c of the vessel 5, and hence can be freely rotatively moved in the vessel. At the one end of the rotary shaft 9, a plate-like coupling plate 24 is provided which is coupled with the driving device 26 arranged on the upper cap 2 to rotate the linkage mechanism 8 back and forth. The coupling plate 24 has a groove 24a to be engaged with a driving coupling pin 30a of the driving device 26 described later.

The ladle 11 is formed in a sack shape with an opening (ladling mouth section) 11a at the one end. The ladle 11 has a soup accommodating section 11b for ladling the soup in the inside thereof. The soup accommodating section 11b also has a partitioning plate (separating member) 38 which partitions itself into a front side and a rear side. The ladle 11, on its upper part, is provided with an opening 11f formed so as to extend in the depth direction. A cover plate 20 is provided to cover the opening 11f. The cover plate 20 is provided with an air vent (through-hole) 20a for removing the internal air when the soup is accommodated in the soup accommodating portion 11b). The air vent 20a is located at the position in the vicinity of the partitioning plate 38 and leading to the soup accommodating portion on the inner side. Incidentally, the cover plate 20 is secured to the upper face of the ladle 11 by a securing screw 15.

The ladle 11 is provided, on the bottom, with a scraper (scraping unit) 39 in contact with the bottom 5b of the vessel 5. The scraper 39 is designed so that its bottom 39a follows the bottom 5b of the vessel 5. When the linkage mechanism 8 rotatively moves within the vessel 5, the scraper 39 slides over the bottom 5b while its bottom is in wide contact with the bottom 5b of the vessel 5. The rear 39b of the scraper 39 is formed to cover the rear lid of the ladle 11 to protrude rearward in a wedge shape. Therefore, when the ladle 11 rotatively moves rearward in the direction opposite to the opening 11a, the wedge shape stirs the substances mixed in the soup in the vessel 5 so that they are spread.

The partitioning plate 38 includes a planar partitioning plane section 38a which partitions the soup accommodating section 11b into an opening 11a side and a inner side, and bending sections 38b formed by bending both sides of the partitioning plane section 38a toward the inner side. The partitioning plane section 38a has slits 38c which do not pass the substances having a prescribed shape contained in the soup and passes only the soup liquid. The bending sections 38b are rotatably journaled on both sides of the ladle 11 by a supporting shaft 45, respectively. On the inner side of the upper end of the bending section 38b, a stopper section 38d is formed to control the rotative movement of the partitioning plate 38 from the partitioning position to the inner side. The portioning plate 38 configured in this manner is rotatively movable freely toward the opening 11a side around the supporting shaft 45. Further, since the position of center of gravity of the portioning plate 38 thus formed is located at the position close to the opening 11a side with respect to the supporting shaft 45, the partitioning plate 38, while being rotatively urged to the inner side of the soup accommodating section 11b as indicated by arrow A in FIG. 7, is kept at the partitioning position where the soup accommodating portion 11b is partitioned into the opening 11a side and the inner side.

The ladle 11 having such a partitioning plate 38 is journaled on the tip of the linkage mechanism 8 so that it is rotatively movable with its opening 11a oriented toward the hopper 40 provided in the vessel 5. When the ladle 11 rotatively moves toward the hopper 40 in the vessel 5, it ladles up the soup with a prescribed ratio between the substances and soup liquid in the soup so that the substances mixed in the soup are accommodated on the opening 11a side of the partitioning plane section 38 in the soup accommodating portion 11b whereas the soup liquid is accommodated on the inner side.

The driving device 26 provided in the upper cap 2 includes a driving motor 28, an driving arm 27 secured to the rotary shaft 28a of the driving motor 28, a driving linkage piece 30 with one end journaled on the tip of the driving arm 27, a guiding shaft 29 engaged in a long slot 30b provided longitudinally along the driving linkage piece 30 and a driving coupling pin 30a engaged in a groove 24a formed on the coupling plate 24 of the linkage mechanism 8 provided at the other end of the driving linkage piece 30. In the driving device 26 thus configured, when the driving motor 28 is energized, the driving arm 27 rotates with the rotary shaft 28a so that the driving linkage piece 30 journaled on the tip of the driving arm 27 swings while being guided by the guiding shaft 29 engaged in the long slot 30b. Further, by the driving coupling pin 30a provided at the other end of the driving linkage piece 30, the coupling plate 24 of the linkage mechanism 8, engaged therewith is rotatively moved around the rotary shaft 9 so that the linkage mechanism 8 is rotatively moved. In this way, the linkage mechanism 8 is rotatively moved by the rotation of the driving motor 28.

In the soup supplying apparatus configured as described hitherto, an explanation will be given of the functions and operations of the respective components where the soup accommodated in the vessel 5 is sub-divided into the plateware 16.

First, the linkage mechanism 8 with the ladle 11 mounted is put in the vessel 5 so that the rotary shaft 9 of the linkage mechanism 8 is attached to the U-shaped grooves 6 provided on the sides 5c of the vessel 5. The soup is poured into the vessel 5 and accommodated therein.

Subsequently, as seen from FIG. 4, the upper cap 2 which closes the upper opening of the apparatus body 1 is rotatively moved upwards to open. The front cover 23 attached to the apparatus body 1 is detached; with the grips 7 of the vessel 5 being gripped, the vessel 5 is mounted in the vessel holding portion 21 of the apparatus body 1. The front cover 23 is mounted in the apparatus body 23 again; the upper cap 2 is rotatively moved downwards to close the upper part of the apparatus body 1. At this time, the driving coupling pin 30a of the driving device 26 provided in the upper cap 2 is engaged in the groove 24a provided in the coupling plate 24 of the linkage mechanism 8. The keeping temperature of the soup is set by the setting button 33 on the control panel 31. In this status, the soup accommodated in the vessel 5 is kept at a predetermined temperature.

Further, in this statue, the soup accommodated in the vessel 5 is stirred by the ladle 11 of the linkage mechanism 8. Concretely, when the driving motor 28 of the driving device 26 provided in the upper cap 2 is energized, the link driving mechanism 8 and the ladle 11 at its tip are rotatively moved backwards in the direction opposite to the opening 11a through the driving linkage piece 30. When they are rotatively moved to e.g. the position inclined by 30° backward (see FIG. 9B), the ladle 11 as well as the linkage mechanism 8 is now rotatively moved forward in an opposite direction (the opening 11a direction). Likewise, when they are rotatively moved to the position inclined by 30° forward, the ladle 11 as well as the linkage mechanism 8 is rotatively moved backward as described above. Such an operation is repeated successively or intermittently. Thus, the soup accommodated in the vessel 5 is stirred by the ladle 11.

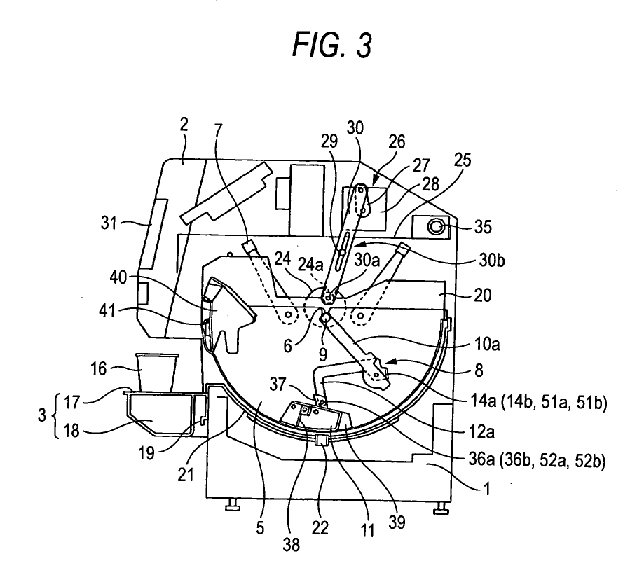

Next, when with the plateware 16 placed on the plateware placing portion 3 and a sub-division starting switch 32 on the control panel 31 is operated, the sub-division operation of the soup is started. Concretely, when the driving motor 28 of the driving apparatus 26 is energized, the linkage mechanism 8 is rotatively moves through the driving linkage piece 30 in the opening 11a direction of the ladle 11 from a stand-by status as shown in FIG. 3. As seen from FIG. 9A, when the linkage mechanism 8 is rotatively moves to a predetermined position e.g. position inclined by 30° forwards, it starts to rotatively in the direction opposite to the opening 11a of the ladle 11. At this time, since the ladle 11 moves with its opening 11a inclined in a slanting-upward direction, the soup proceeds from the opening 11a into the soup accommodating portion 11b. The soup liquid is accommodated in the soup accommodating portion 11b on the inner side through the slits 38c of the partitioning plate 38.

Meanwhile, the ladle 11, on the upper portion, is provided with the air bent 20a. For this reason, even where the slits 38 are narrowed owing to the deposition of the substances on the surface of the partitioning plane 38a, the air in the soup accommodating portion 11b goes out through the air vent 20a. Thus, the soup liquid can be easily accommodated in the soup accommodating portion 11b on the inner side with respect to the partitioning plane 38a. This prevents insufficient accommodation of the soup liquid in the soup accommodating portion 11b.

Further, in this case, the scraper 39 on the bottom of the ladle 11 makes an arc movement along the bottom 5b of the vessel 5 in sliding-contact therewith so that the substances accumulated on the bottom 5b are dispersed in the soup liquid in the vessel 5.

As seen from FIG. 9B, when the linkage driving mechanism 8 rotatively moves to the predetermined position inclined by about 30°, the linkage driving mechanism 8 starts to rotatively move in the opening 11a direction of the ladle 11. At this time, the ladle 11 rotatively moves while accumulating, from the opening 11a, the substances dispersed in the soup liquid in the soup accommodating portion 11b before the partitioning plane 38a. In this case, the soup liquid as well as the substances proceeded from the opening 11a into the soup accommodating portion 11b passes through the partitioning plate 38 to be exhausted externally from the air vent 20a. The substances, therefore, can be effectively accumulated in the soup accommodating portion 11b before the partitioning plane section 38a.

When the rotation further proceeds, as seen from FIG. 9C, the ladle 11 is inserted into the wide mouth 40a of the hopper 40 which is formed to lead to the arc-shaped bottom 5b of the vessel 5. At this time, although the substances and soup liquid are ladled up mixedly on the opening 11a side of soup accommodating portion 11b with respect to the partitioning plane 38a, the soup liquid is exhausted through the slits 38c from the air vent 20a arranged on the inner side (lower side) thereof into the vessel 5. In short, the substances and soup liquid are accommodated in their completely separated state on the opening 11a side and inner side of the soup accommodating portion 11b with respect to the partitioning plane section 38a, respectively. Thus, the substances and soup liquid are always accommodated in the ladle 11 at a prescribed ration therebetween.

When the linkage mechanism 8 further rotatively moves, the ladle 11, while being inserted in the hopper 40 and integral thereto, around the supporting shaft 41 journaling the hopper 40, rotatively moves over the opening 5b of the vessel 5 to the outside thereof as seen from FIG. 9D. Thus, the soup in the ladle 11 is poured into the plateware 16 placed on the plateware placing portion 3. In this case, since the portioning plate 38 within the ladle 11 rotatively moves toward the opening 11a to open owing to the pushing force by the soup liquid accommodated on the inner side, all the substances/dregs as well as the soup liquid proceeded in the soup accommodating portion 11b are discharged. Thus, the soup accommodated within the soup accommodating portion 11b of the ladle 11 is poured into the plateware 16 in a nearly constant state through the hopper 40 from its cylindrical mouth 40b. When the whole soup accommodated in the soup accommodating section 11b has been sub-divided into the plateware 16, the linkage mechanism 8 is rotated in an opposite direction so that the ladle 11 is returned into the vessel 5 again. By such an operation, predetermined quantities of soup are sub-divided from the vessel 5 into the plateware 16.

Incidentally, the opening 5a of the vessel is normally covered with the vessel cover 20 and closed. The vessel cover 20 is provided with a pouring mouth door 20b which is opened owing to pushing force resulting when the ladle 11, while being inserted in the hopper 40 and integral thereto, rotatively moves over the opening 5b of the vessel 5 to the outside thereof.

Meanwhile, the ladle 11, on the upper portion, is provided with the air bent 20a. For this reason, even where the slits 38 are narrowed owing to the deposition of the substances on the surface of the partitioning plane 38a, the air in the soup accommodating portion 11b goes out through the air vent 20a. Thus, the soup liquid can be easily accommodated in the soup accommodating portion 11b on the inner side thereof. This prevents insufficient accommodation of the soup liquid in the soup accommodating portion 11b so that as a whole, the soup can be always ladled up in a predetermined quantity to be sub-divided into the plateware.

Further, the air vent 20a formed at the upper portion of the ladle 11 is located at the position in the vicinity of the partitioning plate 38 and leading to the soup accommodating section 11b on the inner side with respect to the partitioning plate 38. For this reason, when the substances and soup liquid are mixedly ladled up the opening 11a side with respect to the partitioning plate 38, only the soup liquid is exhausted from the air vent 20a to the outside of the ladle 11 through the slits 38c of the separating member. Namely, since a predetermined quantity of substances is ladled up on the opening 11a side 11a with respect to the separating member 38, the substances and soup liquid can be always ladled up at a prescribed ratio and sub-divided into the plateware.

The position of the air vent 20a formed at the upper portion of the ladle 11 can be easily changed by using another cover plate 20 having the air vent 20a formed a different position. Specifically, since the position where the air and soup liquid within the ladle 11 are exhausted can be shifted, the quantity of the soup liquid ladled into the soup accommodating portion 11b can be changed according to the position of the air vent 20a. Thus, the soup at the changed ratio between the substances and the soup liquid can be sub-divided into the plateware.

The shape of the air vent 20a formed at the upper portion of the ladle 11 can be easily changed by using another cover plate 20 having the air vent 20a having a different shape. Specifically, since the shape of the air vent 20a can be changed according to the size of the substances and fluidity of the soup liquid which differ according to the kind of the soup accommodated in the vessel 5, the air vent 20a is prevented from being closed by the substances and soup liquid of the soup. Thus, a predetermined quantity of the soup at a constantly prescribed ratio between the substances and the soup liquid can be ladled up by the ladle 11 and sub-divided into the plateware.

In this way, in accordance with the soup supplying apparatus according to this embodiment, even where the slits 38 are narrowed owing to the deposition of the substances on the partitioning plane 38a of the partitioning plate 38 so that the soup liquid is difficult to be accommodated into the inner side of the soup accommodating portion 11b, the soup liquid can be easily accommodated into the inner side of the soup accommodating portion 11b. Further, even when the percentage of the substances of the soup within the vessel 5 is reduced, the substances can be effectively accumulated on the opening 11a side before the partitioning plate 38 of the ladle 11 to prevent the quantity of the substances to be accommodated from becoming little. Thus, when the soup within the vessel 5 is ladled up by the ladle 11, the soup at a constantly prescribed ratio between substances and the soup liquid can be ladled up and sub-divided into the plateware.

As described above, according to the embodiment, since the air within the ladling member goes out through the through-hole, even where substances are deposited on the surface of the separating member, the soup liquid can be easily accommodated in the inner side of the ladling member with respect to the separating member.

According to the embodiment, when the substances and soup liquid are mixedly accommodated in the ladling mouth side before the separating member, the soup liquid can be exhausted through the separating member from the through-hole to the outside of the ladling member.

According to the embodiment, the position where the air and soup liquid within the lading portion are exhausted can be shifted.

In the embodiment, the shape of the through-hole can be changed according to the size of the substances and fluidity of the soup liquid in the soup accommodated in the vessel.

As described hitherto, according to the embodiment, since the air in the ladling member goes out through the through-hole, even where substances are deposited on the surface of the separating member, the soup liquid can be easily accommodated in the inner side of the ladling member with respect to the separating member. This prevents insufficient accommodation of the soup liquid in the ladling member so that as a whole, the soup can be always ladled up in a predetermined quantity to be sub-divided into the plateware.

According to the embodiemnt, when the substances and soup liquid are mixedly accommodated in the ladling mouth side before the separating member, the soup liquid can be exhausted through the separating member from the through-hole to the outside of the ladling member. Therefore, only a predetermined quantity of the substances can be always accommodated in the ladling mouth side. Thus, the ingredient and soup liquid can be laded up in a predetermined ratio therebetween and sub-divided into the plateware.

According to the embodiment, the position where the air and soup liquid within the lading portion are exhausted can be shifted. Therefore, the quantity of the soup liquid to be accommodated in the ladling member can be changed according to the position of the through-hole. Thus, the soup at the changed ratio between the substances and the soup liquid can be sub-divided into the plateware.

In the invention, the shape of the through-hole can be changed according to the size of the substances and fluidity of the soup liquid (i.e. property of the soup) in the soup accommodated in the vessel. Therefore, the through-hole can be prevented from being closed by the substances and soup liquid constituting the soup. Thus, a predetermined quantity of the soup at a prescribed ratio between the substances and the soup liquid can be always ladled up by the ladling member and sub-divided into the plateware.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A soup supplying apparatus comprising:
a vessel having an opening and accommodates a soup therein;
a ladling member having a ladling mouth and ladles up the soup accommodated in the vessel;
a linkage mechanism provided with the ladling member at one end thereof;
a driving device that rotatively moves the linkage mechanism for ladling up the soup within the vessel and supplying the sub-divided soup into a plateware through the opening; and
a separating member arranged at a position where is backed off from the ladling mouth with a predetermined distance to partition an interior portion of the ladling member into a ladling mouth section and a soup accommodating section, and passes a soup without passing substances mixed in the soup therethrough,
wherein the ladling member has a through-hole formed thereon at a upper part thereof and leading to the soup accommodating section.

2. The soup supplying apparatus according to claim 1, wherein the through-hole is formed on the ladling member at a position in the vicinity of the separating member and leading to the soup accommodating section.

3. The soup supplying apparatus according to claim 1, wherein the position where the through-hole is formed is configured to be shiftable.

4. The soup supplying apparatus according to claim 1, wherein a shape of the through-hole is configured to be changeable.
